(19) United States
(12) Patent Application Publication
(10) Pub. No.: US 2022/0410052 A1
(43) Pub. Date: Dec. 29, 2022

(54) CHANNELIZED METAL SUBSTRATE TO ENHANCE INACTIVATION OF MICROBES

(71) Applicant: COLORADO SCHOOL OF MINES, Golden, CO (US)

(72) Inventor: Terry C. LOWE, Golden, CO (US)

(21) Appl. No.: 17/852,747

(22) Filed: Jun. 29, 2022

Related U.S. Application Data
(60) Provisional application No. 63/216,107, filed on Jun. 29, 2021.

(51) Int. Cl. B01D 46/00; B01D 39/20; B82Y 30/00

(52) U.S. Cl. CPC B01D 46/0028; B01D 39/2031; B82Y 30/00; B01D 2239/0442; B01D 2239/10; B01D 2239/0407

(57) ABSTRACT

The present disclosure is related to surfaces having various topographical features and methods of making same. The disclosed features, created on various polycrystalline metallic substrates, may aid in effectively and rapidly reducing or eliminating detrimental effects of microbes. In some embodiments, the surface features may include channels and combinations of angular features such as ledges, ridges, and nodules, which may help adsorption of microbes to the surface, increase the surface chemical activity, and increase the effective surface area to support and/or accelerate the killing or deactivation of microbes. Some embodiments including reducing radii of curvature on channel ledges, intra-grain angular ridges, and angular nodules to accelerate disruption of microbial outer membranes by charge concentration and charge transfer. Also described are methods of producing the disclosed topographical surface features at low cost on various polycrystalline solid metal surfaces, for example cast, forged, rolled, drawn, wrought, deposited or coated.

### CROSS-REFERENCE TO RELATED APPLICATIONS

This application claims the benefit of priority pursuant to 35 U.S.C. § 119 (e) of U.S. Provisional Patent Application No. 63/216,107, filed Jun. 29, 2021, entitled “Channelized Metal Substrate to Enhance Inactivation of Microbes,” which is hereby incorporated by reference herein in its entirety.

### TECHNICAL FIELD

The present disclosure relates to devices, compositions, and methods related to metallic substrates with surface channels, ledges, ridges, and angular nodules that enhance the antimicrobial effectiveness of the surface of the metal and its metal oxide and a method by which such features can be fabricated.

### BACKGROUND

Bacteria and viruses cause infectious diseases in humans. Bacteria and fungi also damage living organic structures such as wood and inorganic structures such as steels via microbially-induced corrosion. Microbes readily proliferate and migrate, propagating disease and growing damaging biofilms. Antimicrobial agents and methods such as the use of sterilization, disinfectants, physical barriers, filters, physical isolation, and mechanical abrasion help limit the negative impacts of microbes. The mechanisms by which microbes are disabled by liquid disinfectants and solid substances have been extensively reviewed, for example, by Golin, et al. (A. Golin, Amer J Infection Control, 48 (2020) 1062-1067 and by Imani et al. (S. Imani et al., ACS Nano, 14 (2020) 12341-12369). Metal-based antimicrobial surfaces have been analyzed, for example, silver (B. Nowack et al., Environ Science & Tech, 45 (2011) 1177-1183), copper (M. G. Schmidt, et al., Amer J Infection Control, 44 (2016) 203-209), zinc (J. Pasquet, et al. Intl J Pharmaceutics, 460 (2014) 92-100).

It is advantageous to mitigate the damaging effects of microbes as swiftly as possible, especially for pathogenic microbes that promote infectious disease. For example, rapidly reducing the propagation of microbes on personal protective equipment (PPE) such as surgical gowns, commonly touched surfaces such as public transit railings, or filters used in buildings preserve air quality provides obvious benefits to human health. However, the speed at which common antimicrobial solids such as silver and copper deactivate pathogenic bacteria and viruses ranges from minutes to hours, for example as reported by Sunada et al. (Sunada, et al., J. Hazardous Materials 235-236 (2012) 265-270). The purpose of the present disclosure is to describe novel surface topographies on solid metal substrates (and methods of making same) that enhance deactivation of viruses and bacteria faster than conventional surfaces of antimicrobial metals. Furthermore, a chemical treatment method is described that can create the desired surface topographies.

### SUMMARY

The disclosed compositions and methods may comprise topological surface features on a solid metallic substrate and methods by which the surface topologies can be fabricated and/or applied. For example, features can be created on a solid polycrystalline metal substrate with a metallic or metal oxide surface. In some embodiments, a topographical feature may be a channel, for example a concave channel located where the substrate grain boundaries intersect the surface. These concave channels increase the effective surface area, enhance adsorption of microbes to the surface, and facilitate diffusion-controlled mechanisms, for example mechanisms by which metals such as copper, zinc, titanium, and silver inactivate viruses or kill bacteria. In some embodiments, topological features relate to convex angular surface features, for example ledges, ridges, and nodules. It may be helpful from an analytical point of view to model these topological features as ridges, ledges, and/or nodules with characteristic dimensions of a certain size as radii of curvature. However, it should be appreciated that a characteristic dimension may be an irregular, polygonal, or other non-circular shape. As used herein, the terms “radius”, “radii”, and the like are meant to refer to a characteristic dimension of a topological feature, regardless of its shape. The angular surface features may possess a wide distribution of radii of curvature. These angular features may increase effective surface area, increase the surface chemical activity, reaction rates of surface chemical reactions, and result in non-uniform surface charge distribution. In some embodiments, the characteristics of the angular features may depend upon their radii of curvature. In some embodiments, topographical features can be created concurrently, for example by chemical etching. The crystallinity of metals and metal oxides of the disclosed compositions and methods may lead to nanometer-scale curvature of features, such as channels, ledges, ridges, and nodules. Furthermore, the polycrystalline nature of the substrates may provide grain boundaries at the surface that, because of their higher energy state compared to the surrounding intragrain regions preferentially form grain boundary channels in response to chemical etching.

The disclosed features can be manufactured chemically to provide a distribution of curvatures that enhance the disruption of microbes by distinct mechanisms that may depend on their respective radii. For radii of curvature greater than 50 nm, diffusion-limited antimicrobial mechanisms are enhanced. For radii of curvature less than 50 nm, disruption of microbes can be further enhanced via charge transfer from the angular surface architectures. Larger radii angular features enhance chemical activity and diffusion-limited reactions rates. When these same features have smaller radii of curvature they inactivate pathogens via increase in charge concentration and charge transfer. In many embodiments, it may be useful to fabricate the present surfaces to possess a range of radii of curvature to achieve broad-spectrum deactivation of viruses and bacteria. The diversity of surface features can be created by exploiting the crystalline arrangement of atomic planes within each grain of the polycrystalline substrate and the intrinsically higher interfacial energy present at grain boundaries. The diversity of features can be created by a chemical treatment on polycrystalline substrates with a grain size distribution that ranges from 0.15 micrometers to 90 micrometers. For example, a metal particle in the range of 0.15 micrometers to about 90 micrometers may have surface features formed thereon with shapes and sizes that than rapidly deactivate pathogens (e.g., feature sizes with characteristic radii of about 50 nanometers (0.05 micrometers) or smaller). The method can be applied to any 3-dimensional solid polycrystalline metal be it cast, forged, rolled, drawn, otherwise wrought, deposited, sintered, or coated by any means, or additively manufactured, including, but not limited to, rod, bar, plate, sheet, foil, coatings, conversion layers, laminates, wire, mesh, or powder. The enhancement of the antimicrobial effect of these surface features has been measured and is at least a 3-fold greater in the efficacy of deactivating an enveloped virus compared to a planar metal substrate lacking these features.

A material including a metal or alloy surface with an antimicrobial surface topology formed by an etching process. The antimicrobial surface topology is configured to kill or deactivate microbes.

Optionally in some embodiments, a metal content of the surface is 60 weight percent or greater.

Optionally in some embodiments, an average grain size of the surface is between 0.2 microns and 50 microns.

Optionally in some embodiments, the metal or alloy is a three-dimensional solid polycrystalline substrate formed by at least one of casting, solidication, forging, rolling, drawing, wrought, deposition, condensation, coating, or additive manufacturing.

Optionally in some embodiments, the surface topology includes at least one of a ledge, ridge, or nodule with a characteristic dimension.

Optionally in some embodiments, the characteristic dimension is 50 nm or less.

Optionally in some embodiments, the characteristic dimension is a radius of curvature.

Optionally in some embodiments, the material is in the form of one or more of a rod, bar, plate, sheet, foil, coatings, conversion layers, laminate, wire, mesh, or powder.

Optionally in some embodiments, the material includes a channel having a width between 0.1 microns and 5 microns, inclusive.

Optionally in some embodiments, the channel has a depth greater than 0.1 microns.

Optionally in some embodiments, the at least one ledge extends along 70% or more of a total length of an upper portion of a channel

Optionally in some embodiments, the at least one ridge has inter-ridge spacings of less than 50% of a largest grain dimension at a surface of the material.

Optionally in some embodiments, the at least one nodule has a characteristic dimension of 80 nm or less, wherein the nodule is located in an intra-grain region.

Optionally in some embodiments, a composition of the antimicrobial surface topology includes the metal or alloy, or compounds of the metal or alloy in combination with one or more of oxygen, nitrogen, carbon, phosphorous, sulfur, or chlorine.

A method of treating a metal or alloy surface includes: cleaning the surface; rinsing the surface; and etching the surface, wherein the etching is comprises using a mixture of chemicals to produce surface topographical features includes channels and one or more of ledges, ridges, and nodules.

Optionally in some embodiments, the metal or alloy surface comprises one or more of Li, Be, Na, Mg, Al, K, Ca, Sc, Ti, V, Cr, Mn, Fe, Co, Ni, Cu, Zn, Ga, Rb, Sr, Y, Zr, Nb, Mo, Tc, Ru, Rh, Pd, Ag, Cd, In, Sn, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, or Bi.

Optionally in some embodiments, the metal or alloy has a metal content of 60 weight percent or greater.

Optionally in some embodiments, the metal or alloy has an average grain size between 0.2 microns and 50 microns.

Optionally in some embodiments, the metal or alloy is a three-dimensional solid polycrystalline substrate formed by at least one of casting, forging, rolling, drawing, wrought, deposition, coating, or additive manufacturing.

Optionally in some embodiments, channels have widths between 0.1 microns and 5 microns.

Optionally in some embodiments, the channels have depths greater than 0.1 microns.

Optionally in some embodiments, 70% or more of a total length of an upper portion of the channels include ledges.

Optionally in some embodiments, the ridges are positioned within grains of the metal or alloy and inter-ridge spacing is less than about 50% of a largest grain dimension of the surface.

Optionally in some embodiments, intra-grain angular nodules are present with tip radii of curvature less than about 80 nanometers.

Optionally in some embodiments, a composition of the antimicrobial surface topology includes the metal or alloy, or compounds of the metal or alloy in combination with one or more of oxygen, nitrogen, carbon, phosphorous, sulfur, or chlorine.

An air filter includes a fibrous filter media; a plurality of metal or alloy particles coupled to a surface of fibers of the filter media. The plurality of metal or alloy particles have an antimicrobial surface topology formed by an etching process, wherein the antimicrobial surface topology is configured to kill or deactivate microbes.

### DESCRIPTION OF DRAWINGS

The accompanying figures are incorporated into and form part of the specification and illustrate embodiments of the presently disclosed compositions and methods.

FIG. 1 is a two-dimensional cross sectional schematic of a channel (1), a ledge (2), a ridge (3), and a nodule (4) on the surface (5) of a metallic substrate (6)

FIG. 2 is scanning electron micrographs at 5,000× magnification of C110 copper sheet substrate surface topographically modified as specified in one embodiment of the present composition.

FIG. 3 is a 10,000× magnification scanning electron micrograph of C110 copper wire substrate with topographical features as specified in one embodiment of the present composition.

FIG. 4 is a 5,000× magnification scanning electron micrograph of C110 copper powder substrate with topographical features as specified in one embodiment of the present composition.

FIGS. 5A and 5B show baseline decay curves for 99.9% for both treated and untreated Copper meshes. FIG. 5A shows the exponential decay of surviving virions on a linear scale. FIG. 5B shows the same data on a semi-log scale. Each data point represents the average of a minimum of nine replicates.

FIG. 6 shows trials to optimize treatment duration. The image on the left shows results for all timepoints with standard error bars graphed on a semi-log scale. The box indicates the data subjected to statistical analysis and graphed in the image on the right. The 1-minute data was subjected to the Tukey test. The asterisk indicates that there is a statistically significant difference between the 300-second treatment and all shorter duration treatments.

FIGS. 7A and 7B show experimental results with treated powders. FIG. 7A shows data for six different powders on a linear scale. FIG. 7B shows the same data as FIG. 7A on a semi-log scale. The T₅₀ and T_{0.1} values for Zn and stainless steel are shown in gray due to the poor fit to the hypothesis of exponential decay.

FIG. 8A shows an air filter including particles with the surface topology according to the present disclosure. FIG. 8B is a micrograph showing an example of filter filaments with treated particles coupled thereto.

### DETAILED DESCRIPTION

An aspect of the present disclosure relates to addition of linear and nodular surface features that contain a distribution of small radii of curvature to enhance adsorption of microbes to the surface, increase chemical reactivity to accelerate chemistry-dependent antimicrobial reactions, plus at sufficiently small radii, on the scale of 50 nm of less, elevate surface charge concentration to enable charge-based microbe deactivation. For example, the radius of curvature R_{L}, R_{R}, or R_{N} or a ledge, ridge, or nodule, respectively may be less than or equal to 200 nm, 190 nm, 180 nm, 170 nm, 160 nm, 150 nm, 140 nm, 130 nm, 120 nm, 110 nm, 100 nm, 90 nm, 80 nm, 70 nm, 60 nm, 55 nm, 50 nm, 49 nm, 48 nm, 47 nm, 46 nm, 45 nm, 44 nm, 43 nm, 42 nm, 41 nm, 40 nm, 39 nm, 38 nm, 37 nm, 36 nm, 35 nm, 34 nm, 33 nm, 32 nm, 31 nm, 30 nm, 29 nm, 28 nm, 27 nm, 26 nm, 25 nm, 24 nm, 23 nm, 22 nm, 21 nm, 20 nm, 19 nm, 18 nm, 17 nm, 16 nm, 15 nm, 14 nm, 13 nm, 12 nm, 11 nm, 10 nm, 9 nm, 8 nm, 7 nm, 6 nm, 5 nm, 4 nm, 3 nm, or 2 nm and/or greater than or equal to 1 nm, 2 nm, 3 nm, 4 nm, 5 nm, 6 nm, 7 nm ,8 nm, 9 nm, 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, 50 nm, 55 nm, 60 nm, 70 nm, 80 nm, 90 nm, 100 nm, 110 nm, 120 nm, 130 nm, 140 nm, 150 nm, 160 nm, 170 nm, 180 nm, or 190 nm. Typically, the radius or curvature of surface features of an antimicrobial surface topology is on about 50 nm or less. However, in some embodiments, the radius of curvature may be about 200 nm or less.

The present disclosure is related to topographical features created on the surface of polycrystalline metallic substrates including channels and combinations of angular features such as ledges, ridges, and nodules that have been configured to more effectively and rapidly reduce or eliminate the detrimental effects of microbes than conventional antimicrobial surfaces. The channels, ledges, ridges, and nodules increase the adsorption of microbes to the surface, increase the surface chemical activity, and increase the effective surface area to accelerate the killing or deactivation of microbes via the conventional mechanisms by which antimicrobial metals such as copper, silver, titanium, and zinc impart antimicrobial effects. The surface of any metal may be modified according to the methods disclosed herein to include the antimicrobial topological features disclosed herein. In various embodiments, the metallic surface may be one or more of lithium (Li), beryllium (Be), sodium (Na), magnesium (Mg), aluminum (Al), potassium (K), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), rubidium (Rb), strontium (Sr), yttrium (Y), zirconium (Zr), niobium (Nb), molybdenum (Mo), technetium (Tc), ruthenium (Ru), rhodium (Rh), palladium (Pd), silver (Ag), cadmium (Cd), indium (In), tin (Sn), cesium (Cs), barium (Ba), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), gold (Au), mercury (Hg), thallium (Tl), lead (Pb), bismuth (Bi), and/or alloys thereof.

Additionally, the small radii of curvature (e.g., on the order of about 50 nm) created on channel ledges, intra-grain angular ridges, and angular nodules cause charge concentration and charge transfer to accelerate the disruption of the outer membrane of microbes and also disrupt internal microorganism functions. The first part of the disclosed concept may be specification of a topography with channels at grain boundaries to reveal high energy grain facets and create angular ledges. Another part may include addition of intra-grain angular surface features in the form of crystallographic angular ridges and angular nodules with edge or tip radii with a distribution of curvatures that increase chemical activity and, for the smallest radii, create concentrations of electrical charge. The charge concentration provides an additional mechanism of inactivating viruses or killing bacteria via rapid charge transfer from ledges, ridges, and nodules on the substrate surface. Finally, a method is described to produce such topographical surface features at low cost on large areas of polycrystalline solid metal surfaces. The method can be applied to any three-dimensional solid polycrystalline metal substrate be it cast, forged, rolled, drawn, otherwise wrought, deposited or coated by any means, or additively manufactured, including, but no limited to product forms such as rod, bar, plate, sheet, foil, coatings, conversion layers, laminates, wire, mesh, or powder.

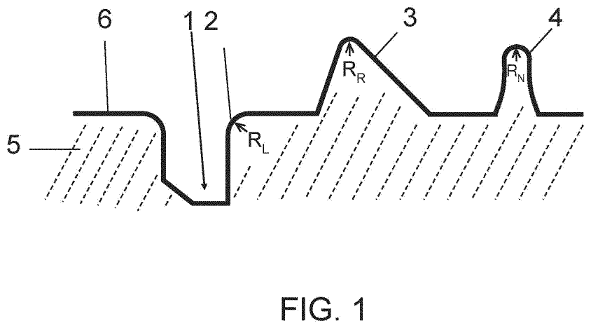

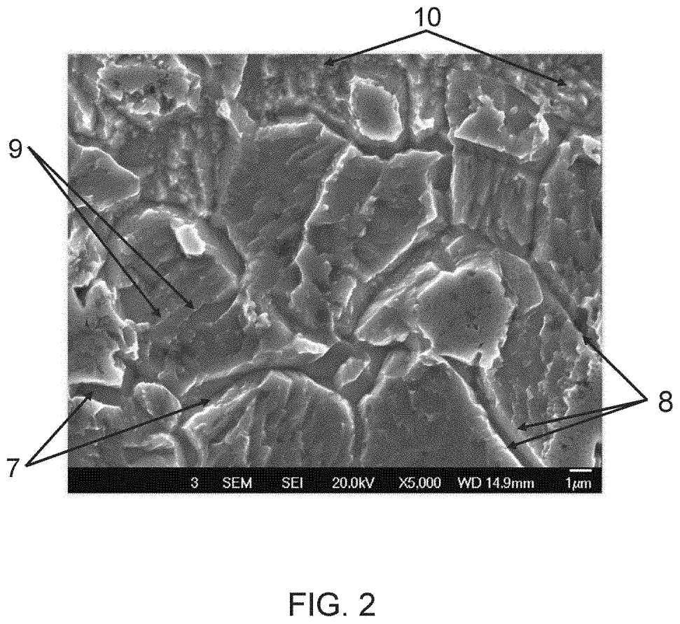

The presently disclosed compositions, devices, and methods are related to antimicrobial topographical features, each of which increases the effectiveness of metal or metal oxide surfaces in deactivating microbes. It also includes a specification of how the topographical features can be fabricated. The disclosure relates to a surface architecture on a polycrystalline metallic substrate that, may contain either or both concave and convex topographical microscale and nanoscale features, that inactivates viruses or kills bacteria more effectively than surfaces lacking such features, individually or in combination. Examples of such antimicrobial topological features are shown schematically in FIG. 1 and are shown in a scanning electron micrograph in FIG. 2 of a metal surface (6). An important aspect of these topographical features is channels (1) in a polycrystalline metallic substrate (5) as shown in FIG. 1. The channels may be located at the intersection of the metallic polycrystalline substrate grain boundaries the surface, as in (7) in FIG. 2. Another example of an antimicrobial topological feature is an angular ledge (2) where the tops of the channels (1) intersect the metal/metal oxide surface (6), e.g., as designated by (2) in FIG. 1 and by (8) in FIG. 2. Another example of an antimicrobial topological feature is an angular ridge the protrudes outwardly from the surface (6) within the grains of the polycrystal, as designated by (3) in FIG. 1 and by (9) in FIG. 2. Another example of an antimicrobial topological feature is an angular nodule extending from the grain surfaces (6), typically between angular ridges (3, 9), as designated by (4) in FIG. 1 and by (10) in FIG. 2.

All antimicrobial topological features disclosed herein enhance antimicrobial effectiveness by (a) increasing the adsorption of microbes to the substrate surface, (b) providing additional surface sites for disruptive chemical reactions, (c) increasing chemical activity due to the presence of curvature, and (d) creating potentially disruptive electrical charge concentrations when the features possess very high radii of curvature. The first of these enhancing effect, (a) aiding adsorption, increases the population of microbes in proximity to the substrate surface. The next two of these enhancing effects, (b) and (c), enhance the release of metal ions from the metal substrate and promote generation of reactive oxygen species, both of which disrupt microbes. Additionally, the channels reveal, at their base, high energy grain boundary facets, which also possess higher chemical activity, which, in turn, enhance the generation of metal ions and reactive oxygen species. Metal ions disrupt the membranes of bacteria and viruses. Reactive oxygen species cause permanent damage to RNA and DNA. In addition, some of the antimicrobial topological featuressuch as ledges, ridges, and nodules cause local concentration of charge when they have sufficiently small radii of curvature (e.g., about 50 nm or less). This small radius of curvature results in a non-uniform distribution of electrical charge over multi-nanometer dimensions on surfaces that, in turn, alters adsorption of microbes and enhances charge transfer (e.g., free electrons) between the surface and microbes. Thus, the antimicrobial topological features 1 features collectively and/or individually: increase adsorption of microbes to the surface, increase the rate of chemical reaction that disrupt microbes, and foster such non-uniformity of distribution of charge to directly disrupt the outer membranes of viruses and bacteria.

The magnitude of enhancement of chemical activity, chemical reaction rates, and additional charge transfer enabled by antimicrobial topological features such as the angular surface ledges, ridges, and nodules is sufficient to enhance the rate and the extent of disruption of the outer membranes of microbes and disable one or more sub-cellular functions that contribute to microbial pathogenicity. The present disclosure, in some embodiments, may include specification of both microscale and nanoscale structures on metallic substrates that make them biocidal. The combination of having features with both concave curvature (e.g., channels) and convex curvatures (e.g., ledges, ridges, and nodules) is novel, as the combination simultaneously enhance microbe adsorption, chemical activity, and charge transfer.

One topographical feature of the present disclosure may be the presence of channels in the surface. Among the roles of channels is their ability to enhance adsorption of microbes, thereby increasing the interaction between the microbes and the antimicrobial effects of metal/metal oxides. The channels provide concavity that creates both a thermodynamic potential and electrical potential difference between the channel and an adjacent planar or convex surface. The magnitude of these potential differences has been calculated from mean-field theory, for example, for a polyelectrolyte and nanoscale channels (Gilles, et al., The Journal of Physical Chemistry C, 122, 2018, 6669-6677). This thermodynamic potential difference enhances the adsoption of microbes to the surface. The degree of enhancement depends upon the radii of curvature, the concentration of ionic species, and the polarity of the membrane proteins and lipids. For electrolytes with concentration less than 10⁻⁴ molar, the charge density and absorption in a surface channel decreases with increasing channel radius. Whereas, for concentration greater than 10⁻⁴ molar the charge density and adsorption from the electrolyte increases on the order of 25% with increasing channel radius. The opposite trend occurs for convex rather than concave shapes. This is important to some embodiments, because in order to enhance microbe adsorption over wide ranges of ion concentrations (10⁻⁶ molar to 10⁻¹ molar) and similarly wide ranging microbe concentrations, it is useful to have both concave features, as provided by channels, and convex features, as provided by ledges, ridges, and nodules Channels on the surface provide the additional benefit of enhancing mechanical attachment. While the magnitudes of effect of each of these topographical features can be measured and modeled, the intent of the present disclosure is to identify their net combined effect on microbial deactivation.

The four types of topographical features influence multiple antimicrobial mechanisms. These mechanisms have been studied by others and extensively reported (P. Bleichert, et al., Biometals 27 (2014) 1179-1189; Grass, et al., Applied and Environmental Microbiology, 77 (2011) 1541-1547). For example, the mechanisms by which copper kills bacteria and inactivates viruses have been shown to depend on the release of copper ionic species (Warnes, et al., mBio, 6 (2015) e10697-15). The rate of release of copper ions depends on the rate of chemical reactions involving copper, which are influenced by the rate of transport of ions, the pH of pathogen-containing solutions, and the chemical driving force for the relevant reactions. These limit the speed at which copper and other metals act as antimicrobial agents. In one embodiment, time-dependent mechanisms may be accelerated by specifying surface structures that enhance the classic mechanisms for deactivating the pathogenicity of microbes and introduce an additional charge-based killing mechanism. Both enhancements depend upon control of the curvature of features on surfaces of metallic substrates. Interactions between surfaces and molecules and organisms depend upon surface curvature. Increases of chemical reaction rates and chemical activity have been reported, for example, for diffusion-limited reactions on curved surfaces (Eun, J. Chem. Phys., 147, (2017), 184112) and for interactions with curved catalytic surfaces (Park, et. Al, Nano Letters, 3, (2003) 1273-1277). In principle, the enhancement of reaction rate on a curved surface should constantly increase with decreasing radii for positive curvature, that is convex curvature, since the exposure to the surrounding media increases, as does the availability of high energy surface sites. However, for spherical convex shapes, there is a competing effect for access of reactants from the media with the reactant sites on the surface. Therefore, there is a maximum enhancement in the reaction rate constant of diffusion-limited reactions of about 2-fold that occurs at a Gaussian curvature K of about 1.6. For a spherical shaped convex curve, the Gaussian curvature is 1/R², where R is the radius of curvature of a sphere. The competition for surface reaction sites increases as R decreases for spherical shapes. However, solid surfaces are not constrained to spherical convexities, as assumed in the analyses by Eun (Eun, Intl J Molecular Sciences, 21 (2020) 997). Ledges and ridges on a surface can possess very small radii of curvature (e.g., about 50 nm or smaller) in the direction perpendicular to their length direction. Whereas, a spherical surface has identical radii of curvature in orthogonal directions, a ridge or ledge can have a small radius of curvature in one direction and a large or near-zero radius of curvature in the orthogonal direction. Thus, the two-fold limitation on enhancement of chemical reaction rate due competition of reaction sites does not apply to ridge-shaped or ledge-shaped surface features. Thus, linear ledges and ridges can enhance surface chemical reactivity more than axially symmetric features such as nodules, needles, or nanowires protruding from the surface. Furthermore, for crystalline surfaces, the net surface energy is increased by the presence of crystallographic ledge and ridge features, for example as shown by Cahn (Cahn, Acta Met., 28 (1980) 1333-1338), Gruber and Mullins (Gruber and Mullins, J. Phys. Chem. Solids, 28 (1967) 875-887) and Surnev et al. (Surnev, et al., Progress in Surf Sci, 53, (1997) 287-296)). However, axisymmetric surface features such as nodules can support higher degrees of charge concentration.

The ability to induce charge concentration via surface curvature can be derived from classical electrodynamics (Ladau and Lifshitz, Electrodynamics of Continuous Media, Pergamon Press, 1960), which shows that the curvature of surfaces causes a non-uniform distribution of surface charge. The theory can be applied to all three convex antimicrobial topological features e.g., illustrated in FIGS. 1 and 2: ledges (2, 8), ridges (3, 9), and nodules (4, 10). This charge concentration phenomenon is known to operate at a wide range of geometric size scales, but novel behaviors emerge when the dimensions and radii of curvature of surface features approach the nanometer scale. From the research of Gilles et al. (Gilles, et al., J Physical Chemistry C, 122, 2018, 6669-6677) the charge density is enhanced multifold on surfaces with radii of curvature less than 50 nm. The electronic structure of Groups 1 and 2 and transition metal Groups 11 and 12 of the periodic table also contributes to the possibility of charge transfer from regions of high curvature. Non-uniform charge distribution has been explored in nanometer scale systems, for example, for nanopatterned silica surfaces immersed in ionic fluids (Ozcelik and Barisik, Phys. Chem. And Chem. Phys., 21, 2019, 7576-7587). The degree of non-uniform surface charge has been predicted to vary with nanoscale roughness, ionic concentration, and pH of the ionic fluid. Such theoretical studies suggest that it should be possible to design surface patterns that can be tailored to produce specific interactions with microbes, especially viruses, which themselves have nanoscale dimensions. For example, it has been shown that “nanosized bumps” on the surface of a conductor can significantly increase the electric field near the bumps (Kozhushner, et al., Journal of Experimental and Theoretical Physics 130, 2020, 198-203). For typical charge densities in metals, the electric field strength at the tip of an asperity 30 atomic lattice spacings in height is a factor of four greater higher than for a flat conductor. This differential in electric field strength can provide the driving force for movement of charge, that is, rapid electron transport in or near such a surface with small radii of curvature such as many be present in angular ledges, ridges, and nodules.

Research on nanoscale structures since the 1990s has addressed the prospective antimicrobial effects of nanoscale structures such as nanoparticles (Seo, et al., Nanoscale, 10 (2018) 15529-15544), nanotextured surfaces (Ellinas, et al., ACS Appl. Mater. Interfaces, 9, 2017, 39781-39789), or nanopillars (Pogodin, et al., Biophysical Journal, 104, 2013, 835-840). This body of research describes how nanoscale features alter the local concentrations of metal ions in solution above a surface or how nanoscale pillars can stretch, penetrate, and rupture the membranes of microbes. For example, nanoscale surface roughness alters the local ion concentration, which can degrade the intracellular processes within microbes. However, this mechanism still depends on the time-limited ion dissolution and transport. The mechanical interaction and microbe membrane rupture by nanopillars has been described for bacteria, but not viruses, which are typically ten-fold smaller than bacteria. The classic chemical mechanisms of antimicrobial action that have been reported can be supplemented by rapid charge transfer from surfaces with non-uniform charge distribution if sufficiently small curvatures can be achieved.

Non-uniformity of charge on a metal surface can be created by adding angular features with specific geometries and spacings. The general principles controlling surface charge are well established and the degree of charge concentration can be computed and measured, for example, as reported by Zhao et al. (Zhao, et al., Nanoscale, 7, 2015, 16298) using a flattened atomic force microscopy probe tip. The forces that can be measured include long range electrostatic effects (on the scale up to 100 nm) and shorter range chemical effects (on the scale less than 1.5 nm). The degree of charge concentration due to the presence of small radii of curvature can be approximated from the mathematical solutions of Bhattaharya (K. Bhattacharya, Physica Scripta 91 (3) (2016) 035501). They analyze surface projections assuming a cone-shape that tapers from its base where it intersects the metal substrate to a vertex extending away from the substrate. Using this approximation, they estimate the charge density σ (Greek letter sigma) at the tip of a cone-shaped projection is proportional to the cone half-angle α as illustrated schematically in FIG. 1 and labeled (2), and expressed by the following equation:

$$σ ∝ \frac{1}{sin ( α ) ln ( tan ( \frac{α}{2} ) )} .$$

where the angle α can be computed from the radius at the base of a surface protrusion, the radius at the top of a protrusion, and the height of the projection. Based on the proportionality from this equation, the amplification of charge attains a minimum for a cone half-angle of 33°, and has higher values for smaller half-angles. For example, consider a needle-like projection with a half-angle α of 1°. The charge density will be 8-fold greater than the minimum value for a half-angle of 33°. This ratio of maximum to minimum charge density decreases with increasing half-angle, to 4.69, 2.43, and 1.57 as the half-angle increases to 2°, 5°, and 10°, respectively. Smaller half-angles increase the degree of geometrically-induced charge concentration. In some embodiments, the surface architectures disclosed herein, such as the nodules possess half-angles less than 10° at their tips. In some embodiments, the ledges at the top of channels and the intra-grain ridges have half angles determined predominantly by the angles between intersecting crystallographic planar surfaces, which are generally greater than 30°. Neverthess, domains of charge concentrations have been reported near 90° ledges on fibers, for example, by Zimmerman, et al. (Zimmerman, et al., J Eng Fiber Fabr., 6, 2011, 61-66). Thus, theoretical models based on classical electrostatics, Poisson-Boltzman theory, Charge Regulation theory, or Derjaguin-Landau-Verwey-Overbeek (DLVO) theory do not yet fully describe charge concentration and interactions with charged surfaces. Therefore, the surfaces intentionally possess a range of curvature radii and full-angles between 2° and 90°, as seen in nodules (4, 10), ledges (2, 8), and ridges (2, 9) apparent in, for example, in the schematic of FIG. 1 and/or the scanning electron micrograph in FIG. 2.

The amount of charge associated with the angular features such as illustrated in FIG. 1 can be estimated by extrapolating from experimental data published for specific nanoscale patterns. For example, Ozcelik, et al. measured charge concentration for nano-patterned surfaces in the presence of an ionic fluid (H. G. Ozcelik, M. Barisik, Electric charge of nanopatterned silica surfaces, Physical Chemistry Chemical Physics 21 (14) (2019) 7576-7587). They found that the surface charge density on 20 nm spherical silica asperities in a 1 mM KC1 ionic fluid was between 7.2×10⁻³ C/m² and 4.9×10⁻³ C/m². Extrapolating from their results and using the proportionality relationship from Bhattaharya, one expects 29 excess electrons will be available at the tip region of each nodule, assuming a spherical shaped nodule with a 20 nanometer radius in a 1 mM ionic fluid, a charge of 1.6×10⁻¹⁹ Coulombs for a single proton or electron. The computed amount of electrons available increases to 460 for an 80 nm diameter nodule and to over 1000 electrons for a 120 nm nodule. Such charge concentrations are large relative to the charge state of microbes. For example, the SARS-CoV-2 virus contains only a small level of intrinsic charge because of its small size, between 60 nm and 120 nm. For comparison, consider that an 80 nm spherical droplet of water has a volume of 2.7×10⁻²² m³ (2680 femtoliters), corresponding to 12.7 million water molecules. The positive charge density present in such a droplet corresponds to the presence of just 1 positively charged hydrogen ion for a pH of 7. If the pH is reduced to 5, then the number of hydrogen ions increases to 89. Similarly, for a 120 nm sphere containing water the number of hydrogen ions is 3 at a pH of 7 and 302 at a pH of 5. Thus, a single virion the size of SARS-CoV-2 could contain a net charge equal to 1 electron and 302 electrons if it were comprised entirely of water at a pH between 5 and 7. But microbes are largely comprised instead of proteins, lipids, and carbohydrates, plus a small amount of ionic fluid. The effective pH of a microbe can be defined by its isoelectric point (IEP), that is, the pH value at which the virus net charge is zero (B. Michen, T. Graule, Isoelectric points of viruses, Journal of Applied Microbiology 109 (2) (2010) 388-397). Experimental data for the IEP of SARS-CoV-2 have been computed for 13 of its proteins by Scheller, et al. (C. Scheller, F. Krebs, R. Minkner, I. Astner, M. Gil-Moles, H. Wätzig, Physicochemical properties of SARS-CoV-2 for drug targeting, virus inactivation and attenuation, vaccine formulation and quality control, Electrophoresis 41 (13-14) (2020) 1137-1151). The assessible exterior membrane protein IEP values are 6.24, 8.57, and 9.51 for the spike protein, membrane protein, and envelope small membrane protein, respectively. These levels of effective pH point out the low level of intrinsic charge present at the surface of the virion, such that the estimated 29 charges available from a 20 nm radius nodule feature to transfer to a single virion will cause significant disruption.

Non-uniformity of charge in channels, ledges, ridges, and nodules on a surface also facilitates adsorption of microbes onto the surface. Regardless of whether capsid proteins of a virus are positively or negatively biased, or whether bacterial membranes and trans-membrane appendages are positively or negatively biased, there will be surface regions of varying charge and polarity that favor adsorption. Charge gradients will facilitate adsorption of microbes onto angular features or onto the surfaces in between the angular features. It is for this reason that the spacings between features should be sufficiently large to allow microbes to adsorb and attach to the substrate surface. In measurements of the effects of nanotopography on forces of adhesion between a nano-smooth surface and an atomic force microscope probe by Rabinovich, et al. (Y. I. Rabinovich, J. J. Adler, A. Ata, R. K. Singh, B. M. Moudgil, Adhesion between Nanoscale Rough Surfaces: I. Role of Asperity Geometry, Journal of Colloid and Interface Science 232 (1) (2000) 10-16) the greatest adhesion was measured for a nano-smooth surface (root mean square roughness of 0.17 nm). The force of adhesion decreased with increasing roughness by a factor of 5 for a 10.5 nm root mean square roughness. Comparable results have been reported for surfaces with mean square roughness roughnesses up to 1500 nm (K. N. G. Fuller, D. Tabor, The effect of surface roughness on the adhesion of elastic solids, Proceedings of the Royal Society of London. A. Mathematical and Physical Sciences 345 (1642) (1975) 327-342). In these studies, the adhesive interaction is greatest with micron-sized particles whose size is greater than the wavelength of modulations in the surface. Consequently, the present disclosure identifies polycrystalline substrates with constituent crystals having sufficiently smooth surface regions spanning dimensions slightly larger than the maximum size of the target microbe to be inactivated. In this way, regions for stable attachment will exist for microbes adsorbed out of carrier fluids. This approach is consistent with the observation that for some strains of bacterial cells, higher levels of attachment are reported for nano-smooth surfaces (S. Wu, S. Altenried, A. Zogg, F. Zuber, K. Maniura-Weber, Q. Ren, Role of the Surface Nanoscale Roughness of Stainless Steel on Bacterial Adhesion and Microcolony Formation, ACS Omega 3 (6) (2018) 6456-6464).

The amount of charge concentration available relative to the charge content within a microbe is overwhelming within the range of concave and convex radii of curvature R between 1 nm and 50 nm. For example, a radius of curvature R_{L} of a ledge (2), a radius of curvature R_{R} of a ridge (3), and/or a radius of curvature R_{N} of a nodule (4), as shown for example in FIG. 1. Thus, a broad range of surface topographies can possess enhanced antimicrobial effects. A preferred and effective combination of convex features characteristics for deactivating a population of microbes is defined here in terms of their spacing. Competing influences are considered to identify the ranges of desirable spacings. To increase adsorption of pathogens, a combination of non-uniform charge and available surface area for microbial adsorption may be balanced. To increase the enhancement of antimicrobial effects due to chemical reaction and ionic species, the surface densities of topographical features should be maximized. Thus, to increase adsorption of microbes to the substrate surfaces surface regions is greater when the feret diameter greater of nearly flat and smooth surface regions is greater than the size of microbes to be targeted for inactivation. But to increase charge non-uniformity having a higher density of charge concentations, especially via the presence of nodular features is desirable. The spacing of linear ridges should also be slightly larger than the size of microbes to be targeted. Thus, in some embodiments the spacing of nodules and ridges should be at least 5% greater the maximum feret diameter intra-ridge or intra-nodule separation distance at the plane where these features emerge above the substrate surface. The sizes of bacteria associated with hospital-acquired infections include staphylococcus aureus with diameters between 0.5 μm and 1.5 μm, pseudomonas aeruginosa with lengths between 1.5 μm to 3 μm and diameters between 0.5 μm to 0.8 μm, and Escherichia coli with lengths of 1.0-2.0 μm and diameters of about 1.0 μm. The smallest viable bacteria has been estimated to be in the range from 0.25 μm to 0.35 μm. This range overlaps the range of sizes for viruses, which spans 0.02 μm to about 0.3 μm. Thus, the diversity of viruses and bacteria that nominally span three orders of magnitude, from 0.02 μm to 3 μm. The size of bacteria varies significantly depending upon the number of ribosomes they contain, which dramatically increases when they are growing most rapidly.

The channels in a substrate surface have multiple roles, including providing the convexity that may enhance microbe adsorption for certain ranges of electrolyte concentrations. A second role is to provide the convex ledges at their intersections with the substrate surface, which provides the convex features needed to enhance charge density. A third role is to provide troughs within which microbes can be retained to increase their contact time with the antimicrobial substrate, especially in the presence of fluid movement above the substrate. For the first two roles, the radii of curvature may be important. For the third role of providing sites for microbe residence, the width of channels may be important. For this role, the width of the channels at grain boundaries on a substrate surface should exceed the size of the target microbe by 5% or greater so that the channels can fully contain the microbe. For example, for a virus with a maximum feret diameter of 120 nm, such as SARS-CoV-2, the channel width needs to be at least 126 nm. The channels (7) shown in FIG. 2 have widths on the order of 1 μm to 2 μm, sufficient for containing, for example, the SARS-CoV-2 virus and most pathenogenic bacteria. The channel widths can be controlled by a method of chemical etching. This etching treatment also determines the dimensions of the ridges and nodules.

The antimicrobial topological features such as channels, ledges, ridges, and nodules can all be produced via chemical etching. The etching process is effective for this purpose on polycrystalline metals because of the intrinsically higher energy of grain boundaries and the effects of crystallography on the response of surfaces to etchants. While the effects of etchants on metal surfaces are well known, the application of specific etchants and etching methods to create antimicrobial surface architectures is novel. Etchants designed to reveal grain boundaries selectively remove metal from the regions of polycrystals where their boundaries intersect the surface. This etching creates the concave surface channels, as in (1) in FIG. 1. The etchants can also transform miniscule geometric pertubations in the intragrain regions of a metallic surface to develop into ridges and nodules. This occurs when more than one crystallographic plane presents itself to the etching medium. Since the surface energy of each crystallographic plane is different, a surface perturbation that simultaneously displays more than one plane will etch more rapidly on the plane with the higher surface energy. This effect encourages the formation of ridges when there are predominantly two such planes exposed to the etchant. The presence of crystallographic slip bands and associated linear surface protrusions provide sites for nucleating the formation of ridges during etching. When more than two planes are exposed, nodules form instead. The shape and symmetry of the nodules reflect the symmetries of the crystallographic planes from which they are derived. Intersecting, non-parallel crystallographic slip bands at the surface can serve as nucleating sites for nodules.

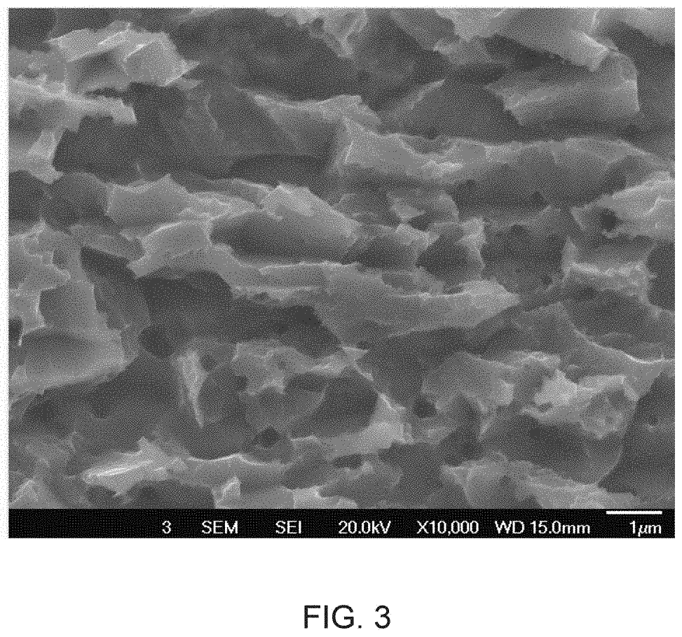

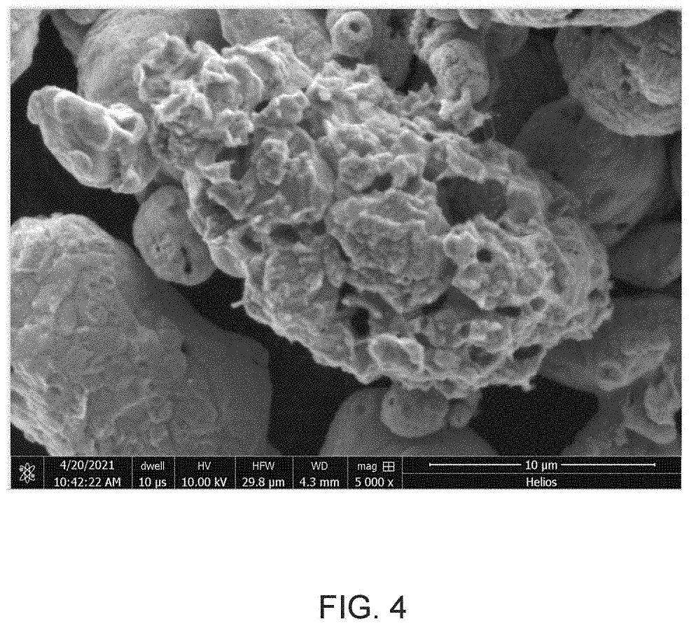

By controlling the concentration, temperature, and time of exposures to an etchant, channels can be formed with specific ranges of widths and depths. In all etching treatments, the surfaces may first be cleaned with isopropanol or acetone. After cleaning, the surfaces to be etched are prepared by rinsing for 10 seconds to 15 seconds using deionized water. Embodiments of the presently described etching process for enhancing the antimicrobial effectiveness of metals are presented for systems within the periodic table of elements including metals and alloys from Group 1 (Li, Na, K), Group 2 (Mg, Ca), Group 11 (Cu, Ag), or Group 12 (Zn), or Group 13 (Al). For aluminum alloys, a preferred embodiement of the etching treatment to channelize grain boundaries may be apply a dilute mixture of hydrofluoric acid (HF), containing 5 mL of 40% HF and one liter of distilled water. The procedure to apply the etchant is complete immersion of the alloy surface with the surface and the etchant at room temperature. For example, for magnesium, a preferred embodiement of the etching treatment may be to apply a mixture of 200 mL and 800 mL of distilled water for up to three minutes, with the surface and etchant both at room temperature. For copper alloys, a preferred embodiement of the etching treatment may be to apply a mixture of 50 grams of iron chloride (FeCl₃) with 150 mL of hydrochloric acid (HCl) and 0.6 liters of methanol, with the copper and the etchant at room temperature. For these examples of embodiments, the period of etching is usually selected to match the scale of topographical features desired on the metal substrate. For example, the embodiment suitable for deactivating microbes smaller than 1 micron in diameter, producing channels with widths between 1 μm and 2 μm, as shown in FIG. 2, can be produced by apply the etchant to C110 copper sheet for 2.5 minutes. The same etchant and etching time can be used to etch C110 copper wires, as shown in FIG. 3, but requires 1.5 minutes for etching a C110 copper alloy powder, as shown in FIG. 4.

The enhancement of the antiviral efficacy of treatment of copper for short exposure periods can be verified by antimicrobial testing, as conducted by the Biology Department of the New Mexico Institute of Mining and Technology. Copper meshes treated to create the surface shown in FIG. 3 were exposed to Phi6 virus, an established surrogate for the SARS-CoV-2 virus, for up to 5 minutes. Meshes with 120 wires/inch and 250 wires/inch were evaluated with and without the surface channelization treatment as described herein. The as-received, untreated copper deactivated on average 15% and 27% of the Phi6 virus after 1 minute of contact for the 120 wire/inch and 250 wire/inch meshes, respectively. In contrast, the same copper meshes deactivated on average 41% and 45% of the virus after 1 minute, and 95% and 99% deactivated after 5 minutes, on 120 mesh and 250 mesh wires, respectively. For the etched 250 wire/inch meshes in particular, the measured amount of virus deactivated after 1 minutes was as high as 97.6%, corresponding to a t₅₀ half-life of 0.3 minutes. Thus, the channelization treatment typically doubled the antimicrobial efficacy after 1 minute, and was shown that it can shorten the half-life for deactivation to a little as 18 seconds.

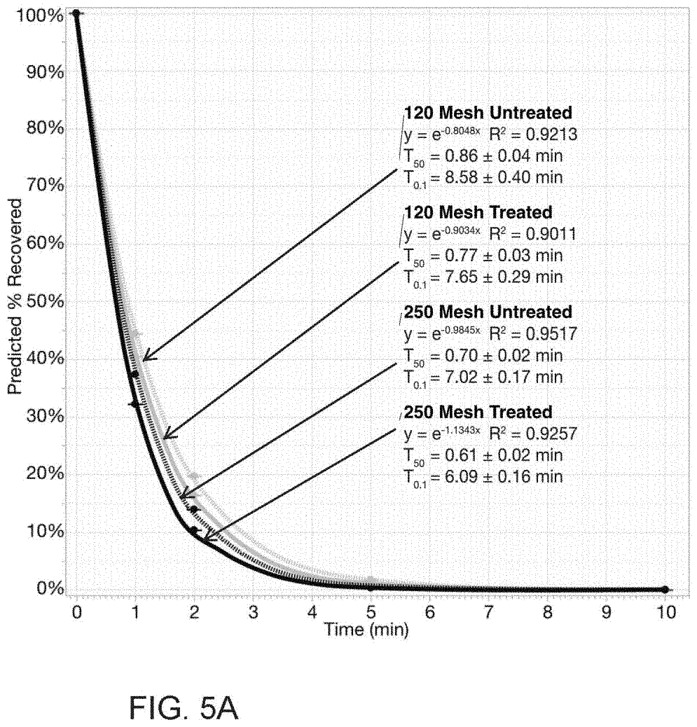

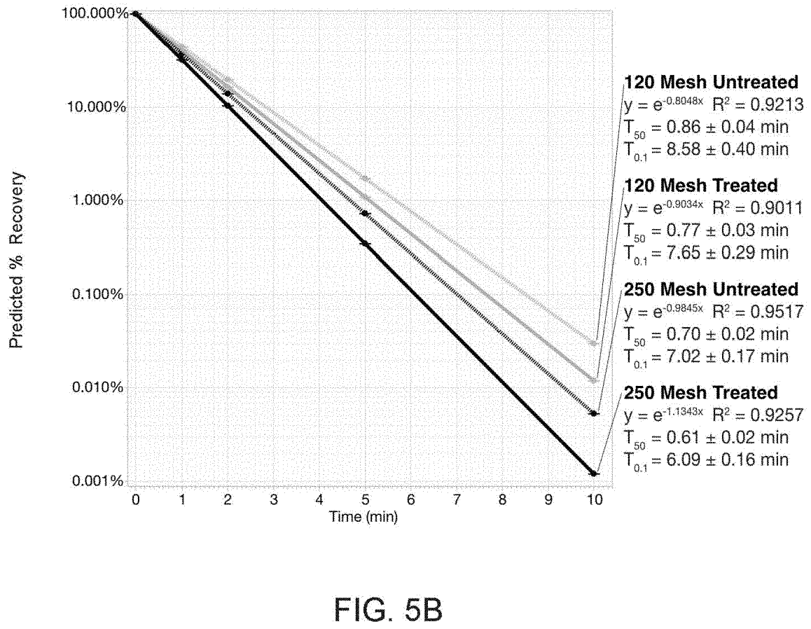

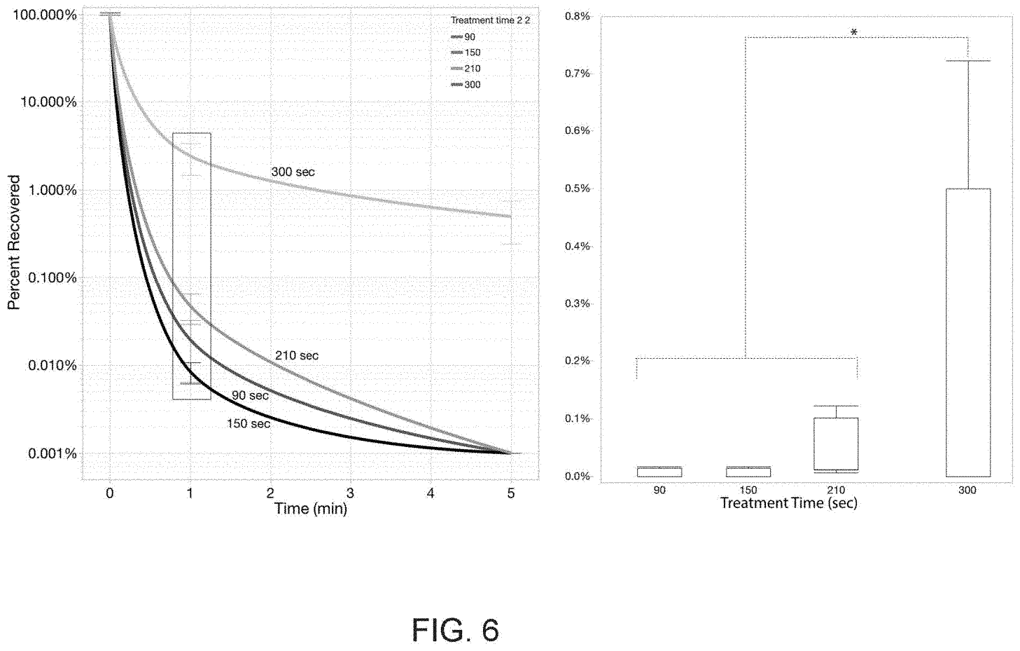

With reference to FIGS. 5A and 5B, 6, 7A, and 7B, experimental results achieved with the surfaces and methods of the present disclosure are presented. Antiviral testing was applied to treated copper wire mesh and powders. Exponential decay constants can be determined from fitting virus neutralization decay curves, which in turn, can be used to estimate the half-life (T50) and 3-log10 (T0.1) neutralization of a virus (equivalent to 10 half-lives.) Different embodiments of the surface treatment process produce varying degrees of antimicrobial effectiveness.

### Antimicrobial Channelized Copper Wire Mesh

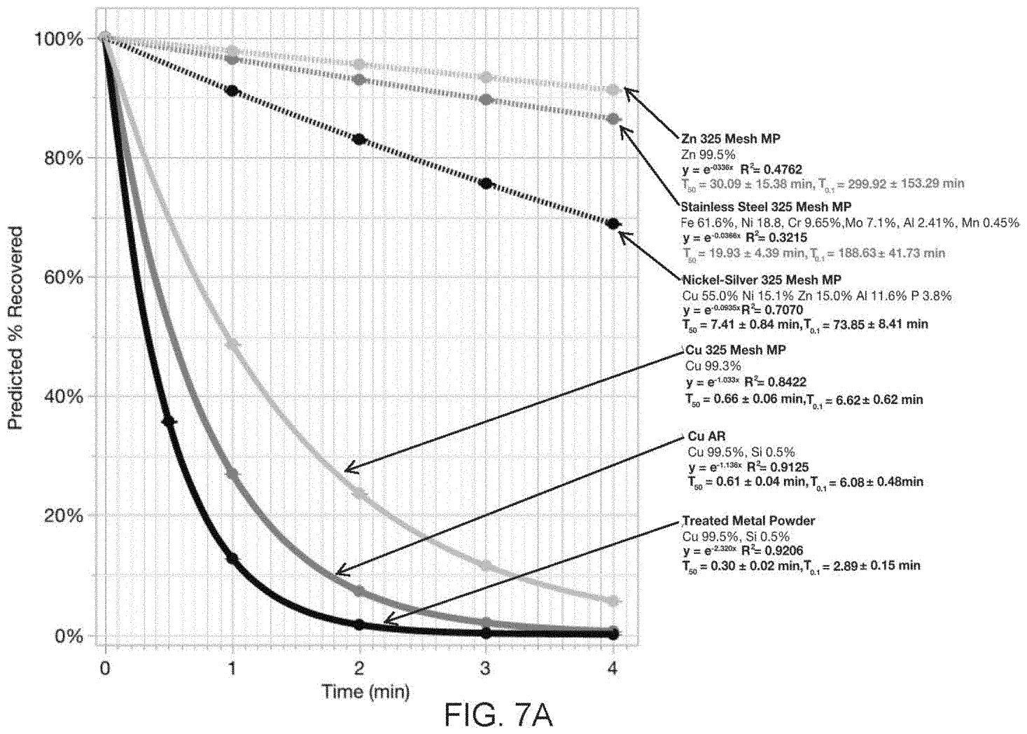

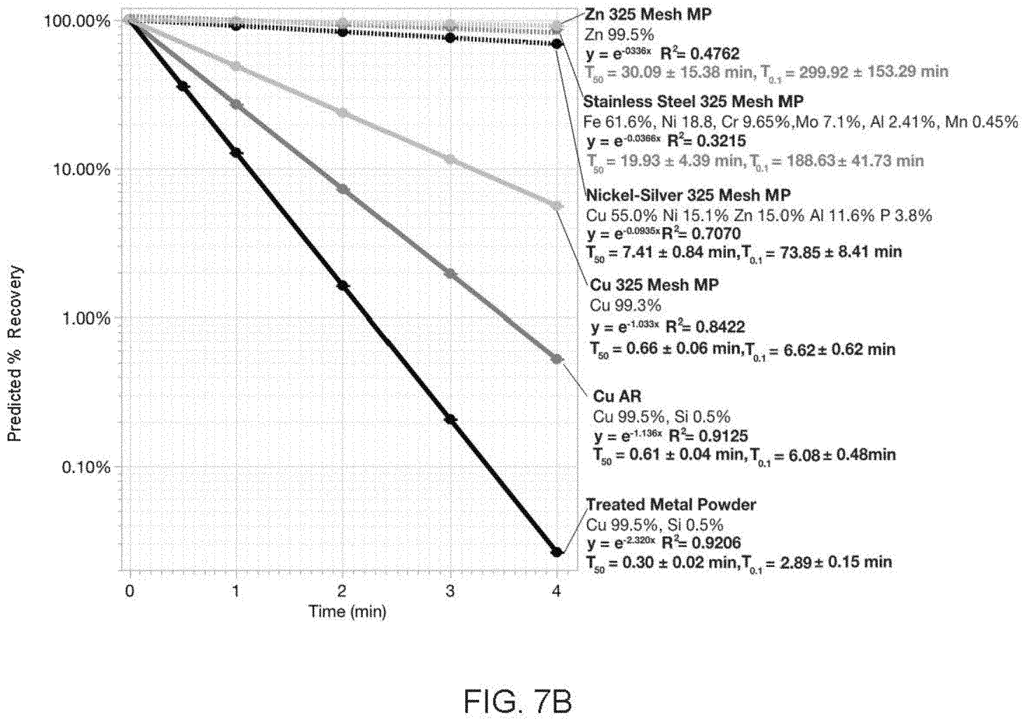

Baseline measurements of antiviral effectiveness were conducted with 99.9% copper wire meshes with either 120 wires/inch or 250 wires/inch. Samples of these meshes were treated for 300 seconds. These meshes were then exposed to the enveloped phi6 virus for 0, 1, 2, 5, and 10 min. The amount of virus recovered that remains intact dramatically decreases with increasing time, as shown in FIGS. 5A and 5B. Experimental trials to optimize treatment duration are presented in FIG. 7

### Antimicrobial Channelized Copper Particles

As shown for example in FIGS. 4, 7A, and 7B, The channelization treatment method can be applied to powders. Copper powders are first cleaned in acetic acid before treatment. Copper, and all other powders tested, are washed prior to antiviral testing to remove any water-soluble contaminants and then filtered to exclude particles <5 μm.

FIGS. 7A and 7B show the results of exposure of treated copper particles to the Phi6 virus for 0.5, 1.0, 2.0, 3.0, and 4.0 minutes. Treatment of Cu powders decreased the T₅₀ time by 50%, from 0.61 min to 0.30 min.

### Example Application

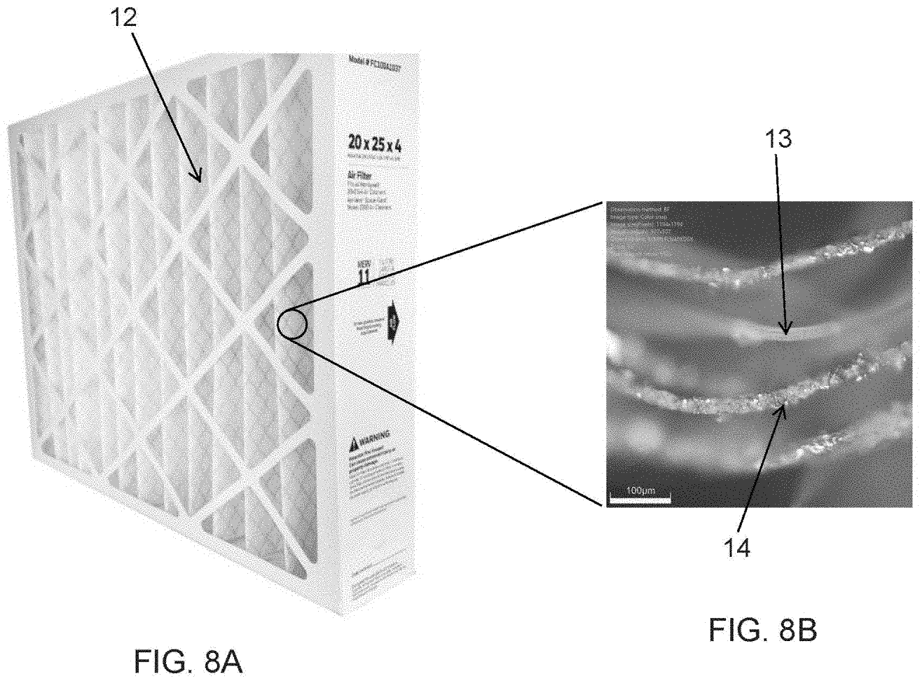

FIGS. 8A shows an air filter 12 including metal particles including the surface topologies, and/or treated according to the methods, disclosed herein. FIG. 8B is a micrograph showing details of the filter of FIG. 8A such as filter filaments 13 with treated metal particles 14 (such as the particles shown in FIG. 4) coupled thereto. In some embodiments, an air filter 12 may include a filter media, such as a fibrous filter media including filaments made from a polymer such as polyester, polypropylene, or other thermoplastics, natural fibers such as cotton, wool, other plant or animal fibers, or the like. In some embodiments, the metal particles may be fused with the fibers by heating the particles to a temperature (e.g., about 70° C.) such that when the particles are placed in contact with the fibers, the fibers at least partially melt thereby fusing the particles with the fibers. Benefits of such a filter may include the ability of the filter to deactivate pathogens as they pass through the filter, thereby generating a sanitized airflow with the filter 12.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

As used herein and unless otherwise indicated, the term “or” are taken to include “or” or “and/or”, and is not intended to be construed as “exclusive or”.

As used herein and unless otherwise indicated, ordinal indicators such as, but not limited to, “first”, “second”, “third”, “nth”, etc. are for identification purposes only and in no way descriptive of the functionality or structure of the claimed or disclosed invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A material including a metal or alloy surface comprising:
an antimicrobial surface topology formed by an etching process, wherein the antimicrobial surface topology is configured to kill or deactivate microbes.

2. The material of claim 1, wherein a metal content of the surface is 60 weight percent or greater.

3. The material of claim 1, wherein an average grain size of the surface is between 0.2 microns and 50 microns.

4. The material of claim 1, wherein the metal or alloy is a three-dimensional solid polycrystalline substrate formed by at least one of casting, forging, rolling, drawing, wrought, deposition, coating, or additive manufacturing.

5. The material of claim 1, wherein the surface topology includes at least one of a ledge, ridge, or nodule with a characteristic dimension.

6. The material of claim 5, wherein the characteristic dimension is 50 nm or less.

7. The material of claim 5, wherein the characteristic dimension is a radius of curvature.

8. The material of claim 1, wherein the material is in the form of one or more of a rod, bar, plate, sheet, foil, coatings, conversion layers, laminate, wire, mesh, or powder.

9. The material of claim 5, further comprising a channel having a width between 0.1 microns and 5 microns, inclusive.

10. The material of claim 9 in which the channel has a depth greater than 0.1 microns.

11. The material of claim 9, wherein the at least one ledge extends along 70% or more of a total length of an upper portion of a channel

12. The material of claim 5, wherein the at least one ridge has inter-ridge spacings of less than 50% of a largest grain dimension at a surface of the material.

13. The material of claim 5, wherein the at least one nodule has a characteristic dimension of 80 nm or less, wherein the nodule is located in an intra-grain region.

14. The material of claim 1, wherein a composition of the antimicrobial surface topology includes the metal or alloy, or compounds of the metal or alloy in combination with one or more of oxygen, nitrogen, carbon, phosphorous, sulfur, or chlorine.

15. A method of treating a metal or alloy surface comprising:
cleaning the surface;
rinsing the surface; and
etching the surface, wherein the etching is comprises using a mixture of chemicals to produce surface topographical features includes channels and one or more of ledges, ridges, and nodules.

16. The method of claim 15, wherein the metal or alloy surface comprises one or more of Li, Be, Na, Mg, Al, K, Ca, Sc, Ti, V, Cr, Mn, Fe, Co, Ni, Cu, Zn, Ga, Rb, Sr, Y, Zr, Nb, Mo, Tc, Ru, Rh, Pd, Ag, Cd, In, Sn, Cs, Ba, La, Ce, Pr, Nd, Pm, Sm, Eu, Gd, Tb, Dy, Ho, Er, Tm, Yb, Lu, Hf, Ta, W, Re, Os, Ir, Pt, Au, Hg, Tl, Pb, or Bi.

17. The method of claim 15, wherein the metal or alloy has a metal content of 60 weight percent or greater.

18. The method of claim 15, wherein the metal or alloy has an average grain size between 0.2 microns and 50 microns.

19. The method of claim 15, wherein the metal or alloy is a three-dimensional solid polycrystalline substrate formed by at least one of casting, solidification, forging, rolling, drawing, wrought, deposition, condensation, coating, or additive manufacturing.

20. The method of claim 15, wherein the channels have widths between 0.1 microns and 5 microns.

21. The method of claim 15, wherein the channels have depths greater than 0.1 microns.

22. The method of claim 15, wherein 70% or more of a total length of an upper portion of the channels include ledges.

23. The method of claim 15, wherein the ridges are positioned within grains of the metal or alloy and inter-ridge spacing is less than about 50% of a largest grain dimension of the surface.

24. The method of claim 15, wherein intra-grain angular nodules are present with tip radii of curvature less than about 80 nanometers.

25. The method of claim 15, wherein a composition of the antimicrobial surface topology includes the metal or alloy, or compounds of the metal or alloy in combination with one or more of oxygen, nitrogen, carbon, phosphorous, sulfur, or chlorine.

26. An air filter comprising:
a fibrous filter media;
a plurality of metal or alloy particles coupled to a surface of fibers of the filter media, wherein:
the plurality of metal or alloy particles have an antimicrobial surface topology formed by an etching process, wherein the antimicrobial surface topology is configured to kill or deactivate microbes.
